(19) United States
(12) Patent Application Publication
(10) Pub. No.: US 2003/0021351 A1
(43) Pub. Date: Jan. 30, 2003

(54) System and method for circulant transmit diversity

(76) Inventor: Shilpa Talwar, Palo Alto, CA (US)

Correspondence Address: Patent Department, Iospan Wireless, P.O. Box 641867, San Jose, CA, 95164-1867, US

(21) Appl. No.: 09/912,800

(22) Filed: Jul. 24, 2001

(51) Int. Cl. H04B 7/06

(52) U.S. Cl. 375/267; 375/347

(57) ABSTRACT

The present invention provides a circulant diversity transmission system. The diversity transmission system includes a method and system of diversity transmission. The method includes forming a stream of symbols from an incoming data stream. A plurality of symbols are selected forming a data vector. The data vector is multiplied with a discrete fourier transform (DFT) matrix forming a transmit vector. A plurality of diversity vectors are generated by circularly rotating the transmit vector. Each diversity vector includes a plurality of elements. Corresponding elements of the diversity vectors are simultaneously transmitted, each diversity vector being transmitted from at least one corresponding antenna of a plurality of spatially separate antennae. The transmission of the diversity vectors can include repeatedly transmitting corresponding elements of the diversity vectors simultaneously until all elements of the diversity vectors have been transmitted, wherein each diversity vector is transmitted from at least one corresponding antenna of a plurality of antennae. Alternatively, transmission of the diversity vectors can include simultaneously transmitting all the elements of the diversity vectors, wherein each is element transmitted within a corresponding frequency slot. The frequency slots can include multiple carrier signals such as orthogonal frequency division mutiplexed (OFDM) signals.

### FIELD OF THE INVENTION

The invention relates generally to wireless communications. More particularly, the invention relates to a system and method of circulant transmit diversity.

### BACKGROUND OF THE INVENTION

Wireless communication systems commonly include information-carrying modulated carrier signals that are wirelessly transmitted from a transmission source (for example, a base transceiver station) to one or more receivers (for example, subscriber units) within an area or region.

A form of wireless communication includes multiple transmit antennae and multiple receiver antennae. Multiple antennae communication systems can support communication diversity and spatial multiplexing.

FIG. 1 shows three transmitter antenna arrays 110, 120, 130 that transmit data symbols to a receiver antenna array 140. Each transmitter antenna array and each receiver antenna array include spatially separate antennae. A receiver connected to the receiver antenna array 140 separates the received signals.

FIG. 2 shows modulated carrier signals traveling from a transmitter 210 to a receiver 220 following many different (multiple) transmission paths.

Multipath can include a composition of a primary signal plus duplicate or echoed images caused by reflections of signals off objects between the transmitter and receiver. The receiver may receive the primary signal sent by the transmitter, but also receives secondary signals that are reflected off objects located in the signal path. The reflected signals arrive at the receiver later than the primary signal. Due to this misalignment, the multipath signals can cause intersymbol interference or distortion of the received signal.

The actual received signal can include a combination of a primary and several reflected signals. Because the distance traveled by the original signal is shorter than the reflected signals, the signals are received at different times. The time difference between the first received and the last received signal is called the delay spread and can be as great as several micro-seconds.

The multiple paths traveled by the modulated carrier signal typically results in fading of the modulated carrier signal. Fading causes the modulated carrier signal to attenuate in amplitude when multiple paths subtractively combine.

Antenna diversity is a technique used in multiple antenna-based communication system to reduce the effects of multi-path fading. Antenna diversity can be obtained by providing a transmitter and/or a receiver with two or more antennae. These multiple antennae imply multiple channels that suffer from fading in a statistically independent manner. Therefore, when one channel is fading due to the destructive effects of multi-path interference, another of the channels is unlikely to be suffering from fading simultaneously. By virtue of the redundancy provided by these independent channels, a receiver can often reduce the detrimental effects of fading.

While prior art wireless transmitter diversity systems mitigate the effects of fading, prior art wireless transmitter diversity systems generally require complex receivers. Prior art wireless transmitter diversity systems can also require complex transmitters. Some prior art wireless transmitter diversity systems require a reduction in transmission rates when utilizing more than two transmit diversity antennae. Additionally, some prior art wireless transmitter diversity systems require feedback from the receiver to the transmitter.

It is desirable to have a method and system that provides a diversity transmitter system for wirelessly transmitting information that results in minimal loss of the transmitted information due to fading and multipath. It is desirable that the transmitter diversity system include a simple receiver design. Additionally, it is desirable that the transmit diversity system not require a reduction in transmission rates when utilizing more than two transmit antennae. It is desirable that the transmit diversity system not require feedback from the receiver to the transmitter.

### SUMMARY OF THE INVENTION

The invention includes a method and system for circulant diversity transmitter that includes a simple receiver design. The circulant diversity transmitter does not require a reduction in transmission rate when transmitting from more than two antennae. Additionally, the circulant diversity transmitter does not require feedback from a receiver.

A first embodiment of the invention includes a method of diversity transmission. The method includes forming a stream of symbols from an incoming data stream. A plurality of symbols are selected forming a data vector. The data vector is multiplied with a discrete fourier transform (DFT) matrix forming a transmit vector. A plurality of diversity vectors are generated by circularly rotating the transmit vector. Each diversity vector includes a plurality of elements. Corresponding elements of the diversity vectors are simultaneously transmitted, each diversity vector being transmitted from at least one corresponding antenna of a plurality of spatially separate antennae.

The transmission of the diversity vectors can include repeatedly simultaneously transmitting corresponding elements of the diversity vectors until all elements of the diversity vectors have been transmitted, wherein each diversity vector is transmitted from at least one corresponding antenna of a plurality of spatially separate antenna. Alternatively, transmission of the diversity vectors can include simultaneously transmitting all the elements of the diversity vectors, wherein each is element transmitted within a corresponding frequency slot. The frequency slots can include multiple carrier signals such as orthogonal frequency division mutiplexed (OFDM) signals.

The plurality of selected inputs symbols can include Mₜ symbols, wherein each diversity vector is transmitted from a corresponding one of Mₜ spatially separate transmit antennae. Alternatively, the plurality of selected inputs symbols can include less than Mt symbols or more than Mₜ symbols, and be transmitted from Mₜ transmit antennae. An embodiment of the invention includes Mₜ being a power of two.

Another embodiment of the invention includes the spatially separate antennae being co-located at a single base transceiver station. Another embodiment of the invention includes the spatially separate antennae being located at a plurality of base transceiver stations.

Another embodiment of the invention includes a transmitter providing transmission of corresponding elements of the diversity vectors, and a number of diversity vectors formed being determined by a receiver characterizing a channel matrix between the transmitter and the receiver.

Another embodiment of the invention includes a transmitter providing transmission of corresponding elements of the diversity vectors, and a number of symbols selected being determined by a receiver characterizing a channel matrix between the transmitter and the receiver.

Another embodiment of the invention includes a transmitter providing transmission of corresponding elements of the diversity vectors, and an order of the symbols formed from the incoming data stream being dependent upon characteristics of a channel matrix between the transmitter and the receiver.

Another embodiment of the invention includes a method of diversity reception. The method of diversity reception includes receiving a plurality of circularly rotated transmit vectors that were formed by multiplying a plurality of symbols with a discrete fourier transform matrix. Transmitted symbols are estimated from the received circularly rotated transmit vectors. The transmitted symbols estimation from the circularly rotated transmit vectors can be performed by a maximum likelihood receiver. The maximum likelihood receiver can use a decoding process that provides more weight to decoding symbols having a high signal to noise (SNR) ratio.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a prior art wireless system that includes spatially separate transmitter antennae and spatially separate receiver antennae.

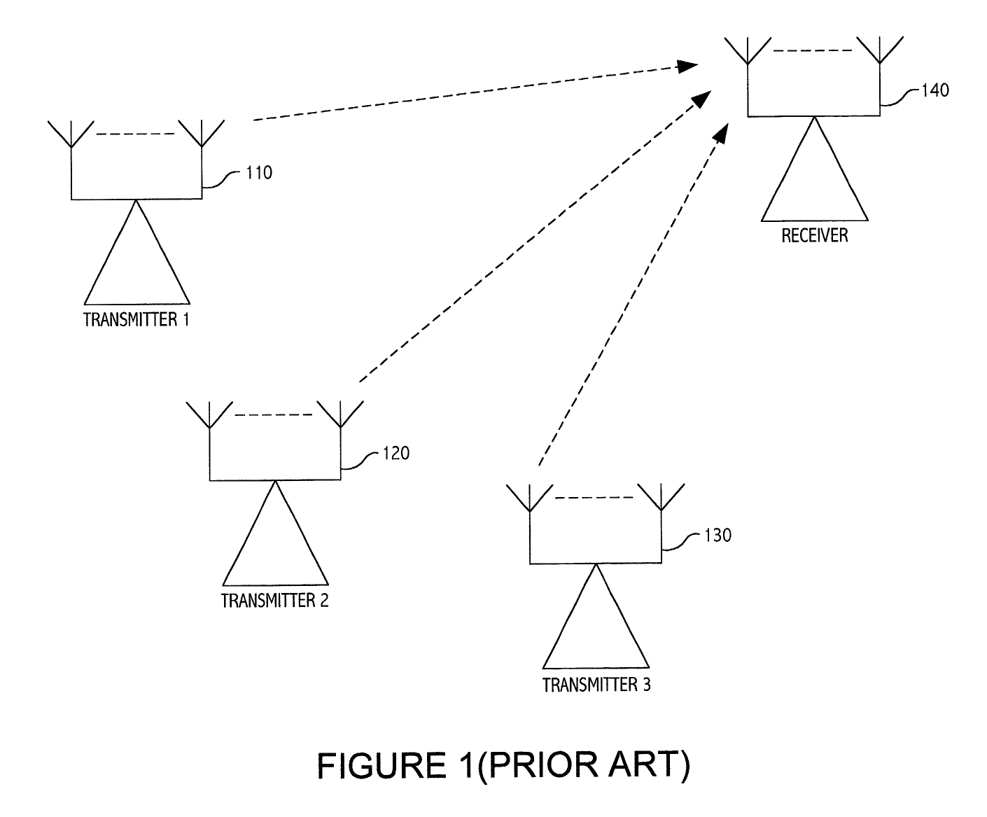

FIG. 2 shows a prior art wireless system that includes multiple paths from a system transmitter to a system receiver.

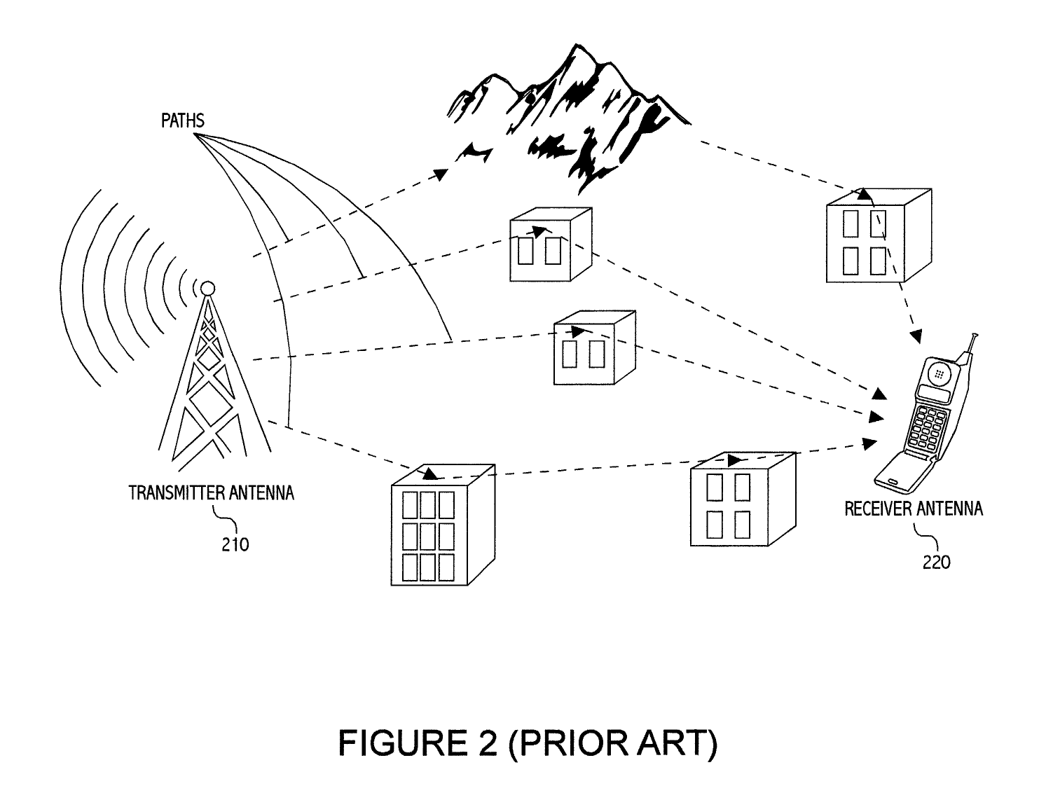

FIG. 3 shows an embodiment of the invention.

FIG. 4 shows another embodiment of the invention.

FIG. 5 shows a block diagram of a transmitter according to the invention.

FIG. 6 shows a block diagram of a receiver according to the invention.

FIG. 7 shows a frequency spectrum of orthogonal frequency division multiplexing (OFDM) sub-carrier signals.

FIG. 8 is a flow chart showing steps included within an embodiment of a transmitter according to the invention.

FIG. 9 is a flow chart showing steps included within an embodiment of a receiver according to the invention.

### DETAILED DESCRIPTION

As shown in the drawings for purposes of illustration, the invention is embodied in an apparatus and a method for generating a plurality of processed transmission symbol streams based on an incoming symbol stream, and transmitting the processed transmission symbol streams over a plurality of transmitters. The invention further includes receiving the processed transmission symbol streams, and extracting the original pre-transmission symbol stream. The processing mitigates the effects of fading and multi-path. The invention allows for a simple receiver design, does not require a reduction in transmission rates when transmitting from more than two antennae, and does not require feedback from a receiver.

Particular embodiments of the present invention will now be described in detail with reference to the drawing figures. The techniques of the present invention may be implemented in various different types of wireless communication systems. Of particular relevance are cellular wireless communication systems. A base station transmits downlink signals over wireless channels to multiple subscribers. In addition, the subscribers transmit uplink signals over the wireless channels to the base station. Thus, for downlink communication the base station is a transmitter and the subscribers are receivers, while for uplink communication the base station is a receiver and the subscribers are transmitters. The subscribers may be mobile or fixed. Exemplary subscribers include devices such as portable telephones, car phones, and stationary receivers such as a wireless modem at a fixed location.

The base station is provided with multiple antennas that allow antenna diversity techniques and/or spatial multiplexing techniques. In addition, each subscriber can be equipped with multiple antennas that also permit spatial multiplexing and/or antenna diversity. Although the techniques of the present invention apply to point-to-multipoint systems, they are not limited to such systems, but apply to any wireless communication system having at least two devices in wireless communication. Accordingly, for simplicity, the following description will focus on the invention as applied to a single transmitter-receiver pair, even though it is understood that it applies to systems with any number of such pairs.

Typically, variations of the wireless channels cause uplink and downlink signals to experience fluctuating levels of attenuation, interference, multi-path fading and other deleterious effects. In addition, the presence of multiple signal paths (due to reflections off buildings and other obstacles in the propagation environment) cause variations of channel response over the frequency bandwidth, and these variations may change with time as well. As a result, there are temporal changes in channel communication parameters such as data capacity, spectral efficiency, throughput, and signal quality parameters, e.g., signal-to-interference and noise ratio (SINR), and signal-to-noise ratio (SNR). The circulant diversity communication system of the invention mitigates the effects of multipath.

Information is transmitted over the wireless channel using one of various possible transmission modes. For the purposes of the present application, a transmission mode is defined to be a particular modulation type and rate, a particular code type and rate, and may also include other controlled aspects of transmission such as the use of antenna diversity or spatial multiplexing. Using a particular transmission mode, data intended for communication over the wireless channel is coded, modulated, and transmitted. Examples of typical coding modes are convolution and block codes, and more particularly, codes known in the art such as Hamming Codes, Cyclic Codes and Reed-Solomon Codes. Examples of typical modulation modes are circular constellations such as BPSK, QPSK, and other m-ary PSK, square constellations such as 4QAM, 16QAM, and other m-ary QAM. Additional popular modulation techniques include GMSK and m-ary FSK. The implementation and use of these various transmission modes in communication systems is well known in the art.

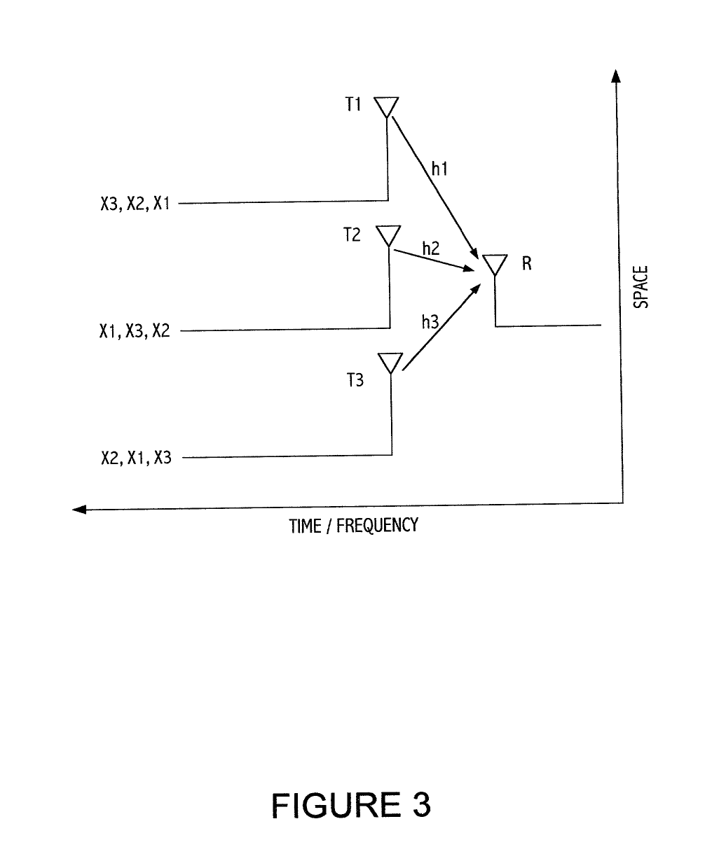

FIG. 3 shows an embodiment of the invention. This embodiment includes three diversity vectors [X3, X2, X1], [X1, X3, X2], [X2, X1, X3] being transmitted from three spatially separate antennae T1, T2, T3. The transmitted diversity vectors are received by a receiver R after traveling through transmission channels h1, h2, h3.

Formation of the Diversity Vectors

The formation of the diversity vectors begins by obtaining a stream of data bits that are to be transmitted. The data stream is generally encoded. The encoding can include a standard coding and interleaving scheme. Additionally, the coding can be optimized for particular channel characteristics.

The encoded stream is mapped into symbols (typically N-QAM). A block of L symbols are selected. An embodiment includes the number L of symbols selected being equal to the number of transmit antennae. For example, if there are Mₜ transmit antennae, then Mₜ symbols are selected (that is, L=Mₜ). Other embodiments of the invention include selecting either fewer or more than Mₜ symbols depending upon characteristics of the transmission channel. That is, L is either greater than or less than Mₜ depending upon characteristics of the transmission channel.

The block of symbols is then multiplied by a discrete-fourier-transform (DFT) matrix Q forming a transmit vector. If the block of symbols includes Mₜ, then the matrix Q has dimensions of Mₜ x Mₜ, and the resulting transmit vector includes Mₜ elements. If Mₜ is a power of two, then the matrix Q is an FFT matrix, and the matrix multiplication can be carried out efficiently. DFT and FFT matrices are well known in the art of digital signal processing.

Generally, the elements of a Q matrix are defined as:

Q_{xy}=(1/\sqrt{F})e^{-(j2π/L)xy}

where x represents the rows of the Q matrix and y represents the columns of the Q matrix. As previously described, L represent the number of symbols within the selected block. L can be equal to Mₜ, which represents the number of transmit antennae.

The transmit vector is then circularly rotated to form more than one diversity vector. Circular rotation includes rotating the elements within the transmit vector incrementally, wherein a diversity vector is formed by each incrementally rotated element. For example, if a transmit vector includes four elements [X1, X2, X3, X4], then four possible diversity vectors [X4, X1, X2, X3], [X3, X4, X1, X2], [X2, X3, X4, X1], [X1, X2, X3, X4] can be formed. Circular rotation involves rotating the elements within the transmit vector.

Mirror images of the above-listed transmit vectors can also be used. For example, the possible diversity vectors can be [X3, X2, X1, X4], [X2, X1, X4, X3], [X1, X4, X3, X2], [X4, X3, X2, X1]

As described earlier, each diversity vector is transmitted from a spatially separate antenna. The diversity vectors of FIG. 3 only include three elements, which corresponds to the number of transmit antennae. However, as previously described, the number of selected symbols L, and therefore, the number of elements within the diversity vectors can be more or less than the number of transmit antennae Mₜ.

The Receiver Configuration

As shown in FIG. 3, the receiver R receives the transmit diversity vectors after the transmit diversity vectors have traveled through transmission channels h1, h2, h3. The receiver forms blocks of L received symbols. An embodiment includes L being equal to Mₜ. The received signals at the receiver can be represented by:

y=Hx+n

From FIG. 3, H can easily be deduced for a transmit diversity system with (Mₜ=L) transmit antennae (note that Mₜ is three in FIG. 3):

$$H = [ \begin{matrix}{h}_{1} & {h}_{2} & … & {h}_{M t} \\ {h}_{M t} & {h}_{1} & … & {h}_{( M t - 1 )} \\ ⋮ & ⋮ & ⋮ & ⋮ \\ {h}_{2} & {h}_{3} & … & {h}_{1}\end{matrix} ]$$

Each element hₖ of the matrix H matrix represents a channel from the transmit antenna k to the receiver, and n is an additive noise vector.

The H matrix is a circulant matrix in which each row is a circular shift of the previous row. It is well known that a circulant matrix has an eigendecomposition:

H=QΛQ*

where Q is the previously mentioned DFT matrix, and Λ is a diagonal matrix of eigenvalues of H. The eigenvalues can be determined as λₖ=q*ₖHqₖ where qₖ is the k^{th} column of matrix Q, and k=1,2, . . . L. Additionally, it is well known in the art that the eigenvalues can be computed more efficiently as λₖ=\sqrt{L}q*ₖh where h is the first column of matrix H.

The receiver can be implemented as a maximum likelihood (ML) receiver. Assuming that the noise n is white Gaussian, the ML receiver minimizes:

ŝarg min∥y−Hx∥²

x=Qs,s∈QAM

which is equivalent to:

$$\begin{matrix}\hat{s} = argmin {‖ y - Q Λ Q * ( Qs ) ‖}^{2} \\ s ∈ QAM\end{matrix}$$

which can be further simplified to

$$\begin{matrix}\hat{s} = argmin {‖ Q * y - Λ s ‖}^{2} \\ s ∈ QAM\end{matrix} .$$

Therefore, the received data vector can be post-processed to form r=Q*y, and each element of s can be obtained by L (Mₜ) independent minimizations:

ŝarg min∥rₖ−λₖs∥², k=1,2, . . . ,L

s∈QAM

In another embodiment, the minimization over each element of s can be equivalently achieved by first computing

\overline{s}ₖ=(1/λₖ)rₖ, k=1,2, . . . , L

and then projecting \overline{s}ₖ to its closest QAM symbol to obtain ŝₖ. The signal-to-noise-ratio (SNR) for estimating ŝₖ is given by

SNRₖ=|λₖ|²SNR

where SNR is the input SNR defined as the average symbol energy divided by variance of additive white Gaussian noise. This SNR information may be used in the decoding process to give more weight to symbols with high SNR values corresponding to more accurate symbol information and thereby yielding improved decoding performance. For example, if the system uses Viterbi coding, the SNR information is used to weight soft-metrics that are input to the decoder.

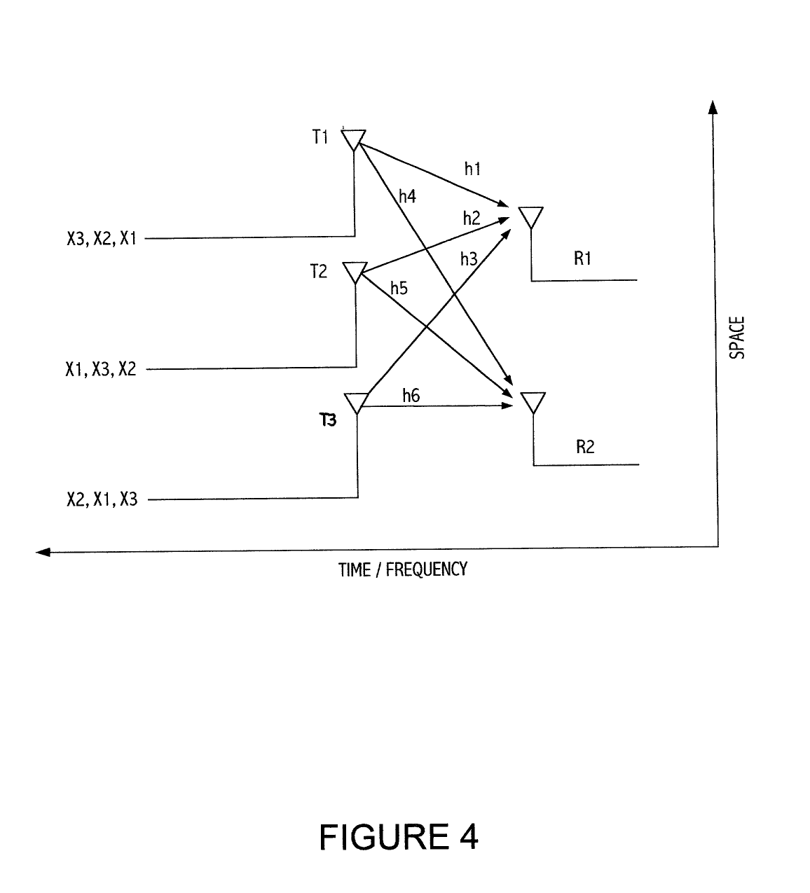

FIG. 4 shows another embodiment of the invention. This embodiment includes a first receiver antenna R1 and a second receiver antenna R2. Channels h1, h2, h3 exist between the transmitter antenna T1, T2, T3 and the first receiver antenna R1. Channels h4, h5, h6 exist between the transmitter antennae T1, T2, T3 and the second receiver antenna R2.

A circulant matrix H exists between the transmitter antennae T1, T2, T3 and each of the receiver antennae R1, R2. Therefore, for the embodiment shown in FIG. 4, a circulant matrix H1 exists for the receive antenna R1 and a circulant matrix H2 exists for the receive antenna R2.

The ML receiver analysis is similar to before. The joint receiver minimizes

ŝ=arg min[∥y₁−H₁x∥²+∥y₂−H₂x∥²]

x=Qs,s∈QAM

where y1 is the block of of L received symbols at receiver R1 and y2 is the block of of L received symbols at receiver R2. Forming r₁=Q*y₁ and r₂=Q*y₂, the above minimization can be simplified to

ŝ=arg min[∥r₁−Λ₁s∥²+∥r₂−Λ₂s∥²]

s∈QAM

It follows from the fact that Λ₁ and Λ₂ are diagonal matrices, that the minimization over the each element of vector s can be carried out independently.

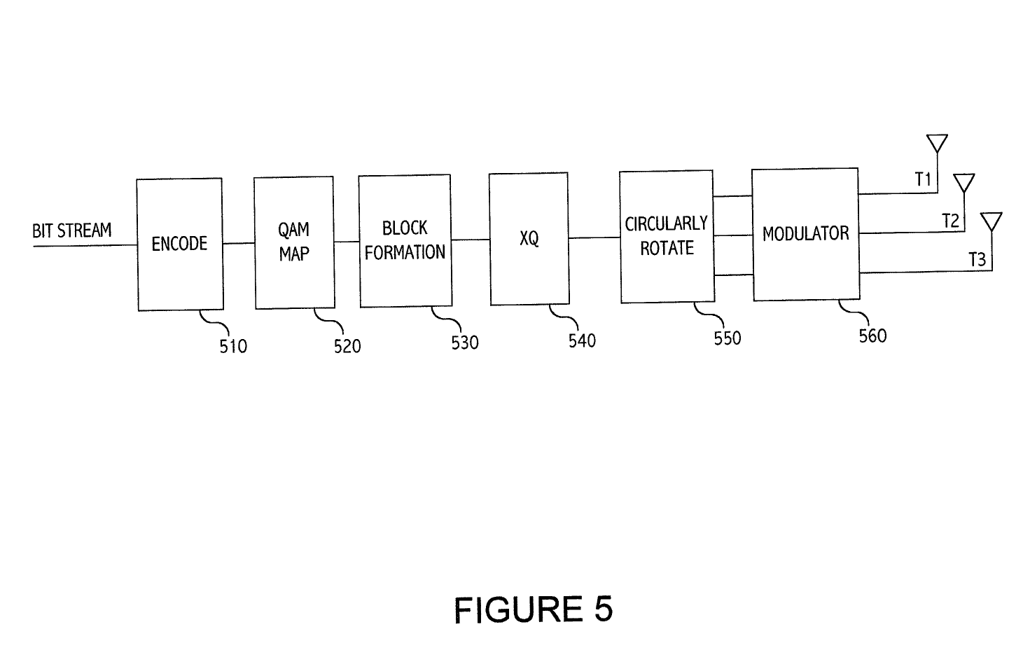

FIG. 5 shows a block diagram of a transmitter according to the invention. As previously described, an encoder 510 receives a bit stream. The encoder encodes the bit stream. The encoding can include convolution and block codes, and more particularly, codes known in the art such as Hamming Codes, Cyclic Codes and Reed-Solomon Codes.

A QAM mapper 520 maps the encoded bit stream into N-QAM symbols. Other typical symbol types can include circular constellations such as BPSK, QPSK, and other m-ary PSK, square constellations such as 4QAM, 16QAM, and other m-ary QAM.

A block former 530 forms blocks that include a predetermined number of symbols. As previously described, the blocks size are typically determined by the number of transmit antennae, but can also be determined by a quality of a channel matrix that represents the transmission channel.

A Q multiplier 540 multiplies the blocks of symbols with a DFT matrix. As previously mentioned, DFT matrices are well known in the art of communication systems.

A circular rotator 550 generates diversity vectors by circularly rotating the output of the Q multiplier 540. Circular rotation includes rotating the elements within the transmit vector incrementally, wherein a diversity vector is formed by each incrementally rotated element.

A modulator 560 modulates carrier signals with the diversity vectors and drives transmit antennae T1, T2, T3. Modulators are well know in the art of communication systems.

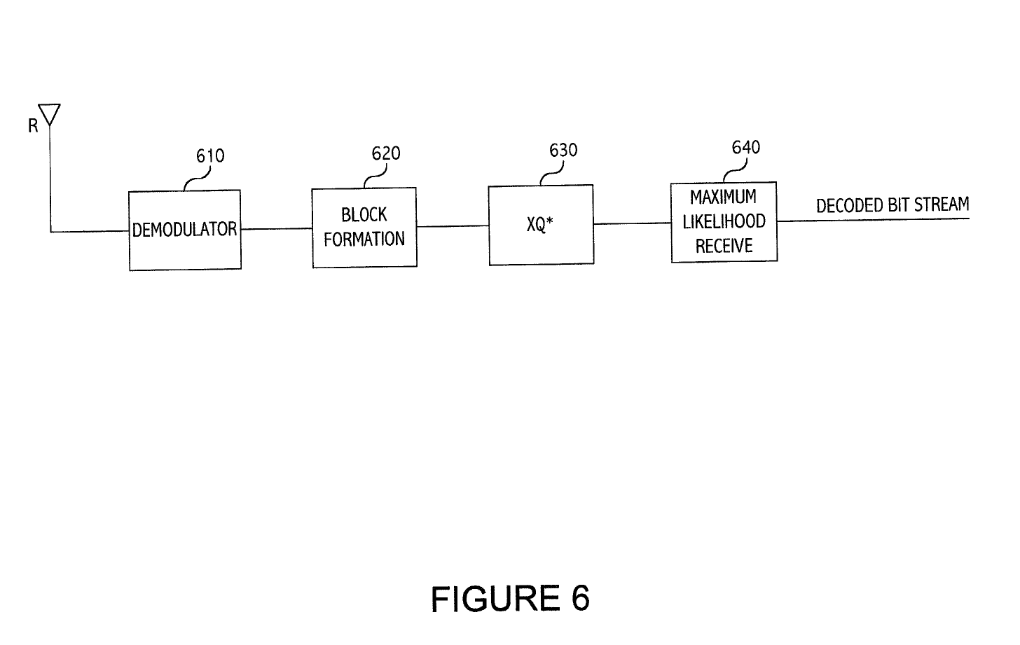

FIG. 6 shows a block diagram of a receiver according to the invention. The receiver includes a receiver antenna R, a demodulator 610, a block former 620, a conjugate transpose DFT matrix multiplier 630 and an estimator 640. The estimator 640 of FIG. 6 is shown as a maximum likelihood (ML) receiver.

The receiver antenna receives the previously described transmitted diversity vectors. As was previously described, the receiver can include multiple receive antennae.

The demodulator 610 demodulates the received diversity vectors and generates a stream of received data samples. Demodulators are well known in the art of communication systems.

A block former 620 selects blocks of the received data samples.

A multiplier 630 multiplies the selected block with a conjugate transpose of the discrete fourier transform matrix. The conjugate transpose of the discrete fourier transform matrix is also known in the art as an iDFT matrix.

A maximum likelihood receiver 640 estimates transmitted symbols from the output of the multiplier. An embodiment includes the maximum likelihood receiver providing more weight to decoding symbols having a high signal to noise (SNR) ratio. Maximum likelihood receivers have been discussed previously.

Orthogonal Frequency Division Multiplexing (OFDM) Modulation

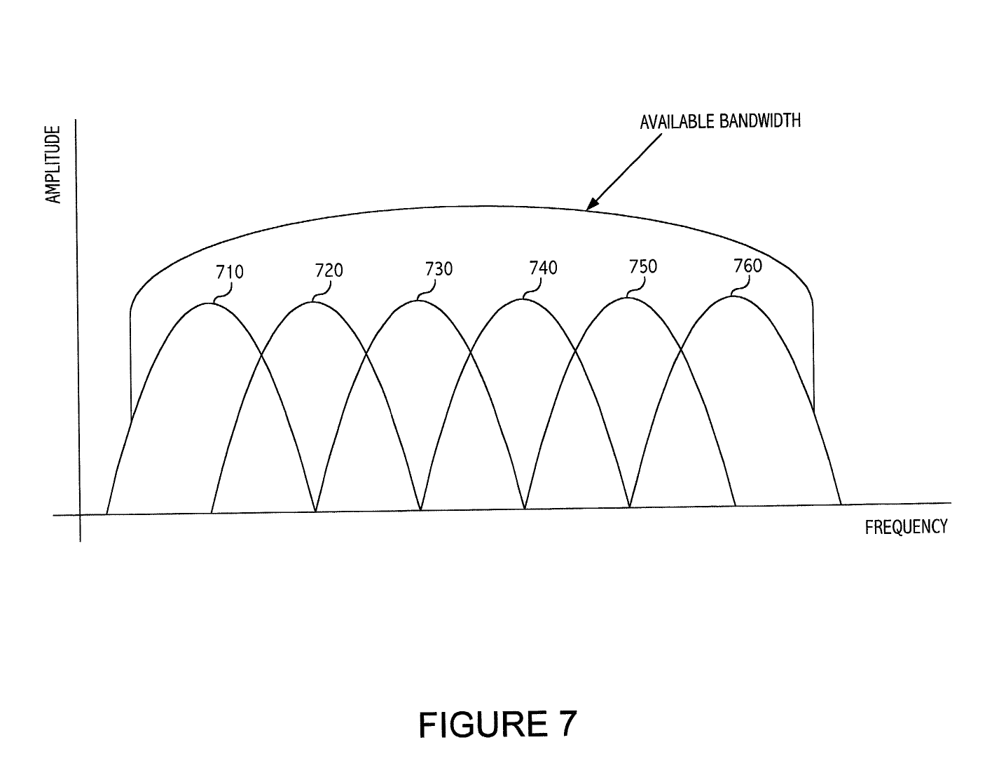

FIG. 7 shows a frequency spectrum of orthogonal frequency division multiplexing (OFDM) sub-carrier signals. Frequency division multiplexing systems include dividing the available frequency bandwidth into multiple data carriers. OFDM systems include multiple carriers (or tones) that divide transmitted data across the available frequency spectrum. In OFDM systems, each tone is considered to be orthogonal (independent or unrelated) to the adjacent tones. OFDM systems use bursts of data, each burst of a duration of time that is much greater than the delay spread to minimize the effect of ISI caused by delay spread. Data is transmitted in bursts, and each burst consists of a cyclic prefix followed by data symbols, and/or data symbols followed by a cyclic suffix.

FIG. 7 shows a frequency spectrum of OFDM sub-carrier signals 710, 720, 730, 740, 750, 760. Each sub-carrier 710, 720, 730, 740, 750, 760 is modulated by a separate linear combination of incoming symbols.

An example OFDM signal occupying 6 MHz is made up of 1024 individual carriers (or tones), each carrying a single QAM symbol per burst. A cyclic prefix or cyclic suffix is used to absorb transients from previous bursts caused by multipath signals. Additionally, the cyclic prefix or cyclic suffix causes the symbol stream to look periodic. Additional symbols (for example 100) are transmitted for the cyclic prefix or cyclic suffix. For each symbol period a total of 1124 symbols are transmitted, by only 1024 unique QAM symbols per burst. In general, by the time the cyclic prefix is over, the resulting waveform created by the combining multipath signals is not a function of any samples from the previous burst. Therefore, no ISI occurs. The cyclic prefix must be greater than the delay spread of the multipath signals.

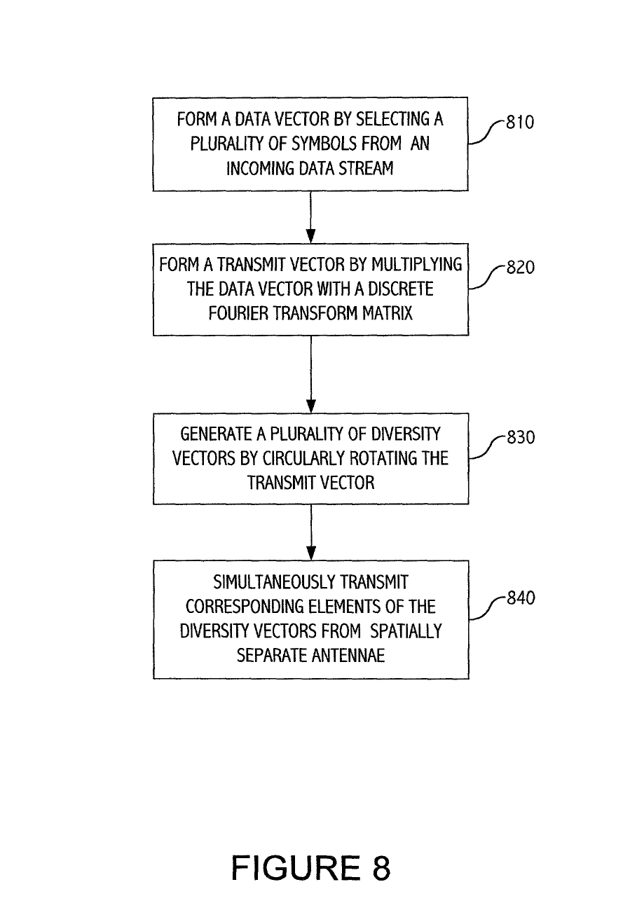

FIG. 8 is a flow chart showing steps included within an embodiment of a transmitter according to the invention. A first step 810 includes forming a stream of symbols from an incoming data stream. A second step 820 includes selecting a plurality of symbols forming a data vector. A third step 830 includes multiplying the data vector with a discrete fourier transform (DFT) matrix forming a transmit vector. A fourth step 840 includes generating a plurality of diversity vectors by circularly rotating the transmit vector, each diversity vector comprising a plurality of elements. A fifth step 850 includes simultaneously transmitting corresponding elements of the diversity vectors, each diversity vector transmitted from at least one corresponding antenna of a plurality of spatially separate antennae.

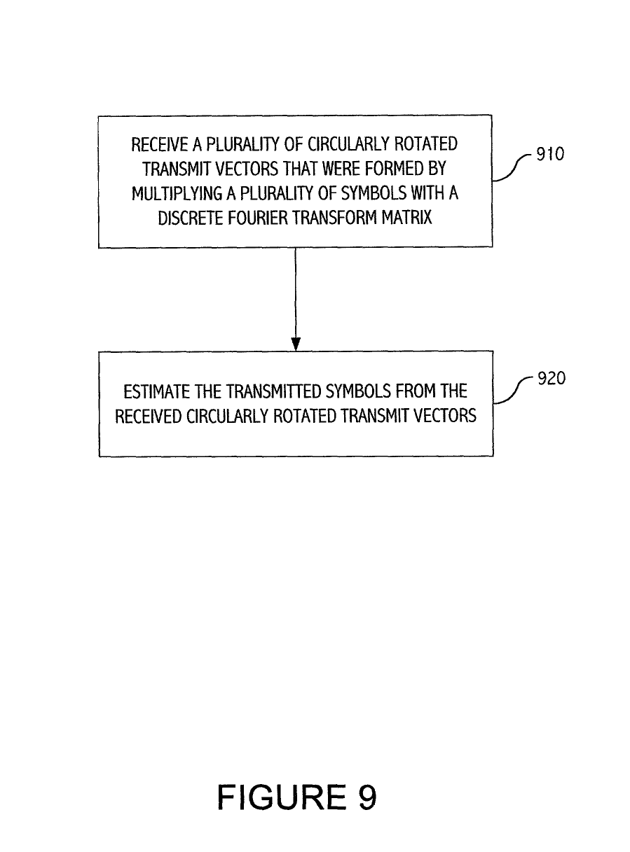

FIG. 9 is a flow chart showing steps included within an embodiment of a receiver according to the invention. A first step 910 includes receiving a plurality of circularly rotated transmit vectors that were formed by multiplying a plurality of symbols with a discrete fourier transform matrix. A second step 920 includes estimating transmitted symbols from the received circularly rotated transmit vectors.

Alternate Embodiments

As previously described, the number of symbols selected during block formation can vary depending upon the quality of the transmission links between the transmit antennae and the receiver antenna. An embodiment of the invention includes adjusting the number of selected symbols based upon characteristics of the channel matrix H. The block size is determined by the receiver since the transmitter has no knowledge of the channel. It was seen earlier that the SNR for each symbol depends on the eigenvalues of the circulant matrix, that is SNRₖ=|λₖ|² SNR. The eigenvalues depend on the channel characteristic and the block size L, λₖ=\sqrt{L}q*ₖh. For a given channel characteristic, changing the block size changes the eigenvalue distribution and consequently the SNR distribution. It must be noted however that changing the block size does not change the average SNR

$${SNR}_{average} = \frac{1}{L} {\sum }_{k = 1}^{L} {SNR}_{k} = ( {\vert {h}_{1} \vert}^{2} + {\vert {h}_{2} \vert}^{2} + … + {\vert {h}_{M t} \vert}^{2} ) SNR ,$$

which depends only on the channel from the transmit antennae to the receiver and the input SNR.

Depending on the channel characteristic, it may be beneficial for the transmitter to change the block size. This can be seen from the following example. Consider a system with two transmit antennae Mt=2 transmitting to receiver R. Let h1 and h2 represent the channel from transmitter T1 and T2 respectively. If block size L=2 is chosen, the eigenvalues of the circulant matrix H are λ₁=h₁+h₂ and λ₂=h₁−h₂. If the channel is such that h₁=h₂, the second eigenvalue λ₂=0 and hence the SNR corresponding to the second symbol is zero. However if block size L=3 is chosen, the eigenvalues of the corresponding circulant matrix H are λ₁=h₁+h₂, λ₂=h₁+e^{j(4π/3)}h₂, and λ₃=h₁+e^{j(8λ/3)}h₂ none of which are zero. Changing the block-size is particularly useful in applications where transmitter is using the same order QAM for all symbols in a block, and it cannot benefit from having high or low SNR's for different elements in the block.

In an alternate embodiment, the transmitter has knowledge of the eigenvalues of the circulant matrix and chooses an optimal coding and modulation scheme based on this information. For example, the transmitter may transmit high order QAM symbols corresponding to high eigenvalues and low order QAM symbols (or perhaps no data) corresponding to low order QAM symbols. In addition, a coding scheme may be chosen that maximizes the capacity of the channel.

Although specific embodiments of the invention have been described and illustrated, the invention is not to be limited to the specific forms or arrangements of parts so described and illustrated. The invention is limited only by the claims.

What is claimed:

1. A method of diversity transmission comprising:
forming a stream of symbols from an incoming data stream;
selecting a plurality of symbols forming a data vector;
multiplying the data vector with a discrete fourier transform (DFT) matrix forming a transmit vector;
generating a plurality of diversity vectors by circularly rotating the transmit vector, each diversity vector comprising a plurality of elements; and
simultaneously transmitting corresponding elements of the diversity vectors, each diversity vector transmitted from at least one corresponding antenna of a plurality of spatially separate antennae.

2. The method of diversity transmission of claim 1, further comprising:
repeatedly simultaneously transmitting corresponding elements of the diversity vectors until all elements of the diversity vectors have been transmitted, each diversity vector transmitted from at least one corresponding antenna of a plurality of spatially separate antenna.

3. The method of diversity transmission of claim 1, wherein simultaneously transmitting corresponding elements of the diversity vectors comprises simultaneously transmitting all the elements of the diversity vectors, each element transmitted within a corresponding frequency slot.

4. The method of diversity transmission of claim 3, wherein each frequency slot comprises at least one multiple carrier signal.

5. The method of diversity transmission of claim 4, wherein the multiple carrier signals are orthogonal frequency division mutiplexed (OFDM) signals.

6. The method of diversity transmission of claim 1, wherein the plurality of selected inputs symbols comprises Mₜ symbols, and each diversity vector is transmitted from a corresponding one of Mₜ spatially separate transmit antennae.

7. The method of diversity transmission of claim 1, wherein the plurality of selected inputs symbols comprises less than Mₜ symbols.

8. The method of diversity transmission of claim 1, wherein the plurality of selected inputs symbols comprises more than Mₜ symbols.

9. The method of diversity transmission of claim 6, wherein Mₜ is a power of two.

10. The method of diversity transmission of claim 1, wherein the spatially separate antennae are co-located at a single base transceiver station.

11. The method of diversity transmission of claim 1, wherein the spatially separate antennae are located at a plurality of base transceiver stations.

12. The method of diversity transmission of claim 1, wherein generating a plurality of diversity vectors by circularly rotating the transmit vector comprises;
shifting transmit vector elements within transmit vector to form each diversity vector.

13. The method of diversity transmission of claim 1, wherein generating a plurality of diversity vectors by circularly rotating the transmit vector comprises;
reversing the order of the elements within the transmit vector; and
shifting the transmit vector elements within the reversed transmit vector to form each diversity vector.

14. The method of diversity transmission of claim 1, wherein a number of diversity vectors formed is equal to a number of transmit vector elements.

15. The method of diversity transmission of claim 1, wherein a number of diversity vectors formed is less than a number of transmit vector elements.

16. The method of diversity transmission of claim 1, wherein a number of diversity vectors formed is greater than a number of transmit vector elements.

17. The method of diversity transmission of claim 1, wherein a transmitter provides transmission of corresponding elements of the diversity vectors, and a number of diversity vectors formed is determined by a receiver characterizing a channel matrix between the transmitter and the receiver.

18. The method of diversity transmission of claim 1, wherein a transmitter provides transmission of corresponding elements of the diversity vectors, and a number of symbols selected is determined by a receiver characterizing a channel matrix between the transmitter and the receiver.

19. The method of diversity transmission of claim 1, wherein a transmitter provides transmission of corresponding elements of the diversity vectors, and an order of the symbols formed from the incoming data stream is dependent upon characteristics of a channel matrix between the transmitter and the receiver.

20. The method of diversity transmission of claim 1, further comprising:
coding the incoming data streams, wherein the coding and an order of the formed symbols is dependent upon eigenvalues of a channel matrix that represents a transmission channel between a transmitter transmitting the diversity vectors and a receiver that receives the diversity vectors.

21. A method of diversity reception comprising:
receiving a plurality of circularly rotated transmit vectors that were formed by multiplying a plurality of symbols with a discrete fourier transform matrix; and
estimating transmitted symbols from the received circularly rotated transmit vectors.

22. The method of diversity reception of claim 21, wherein estimating the transmitted symbols from the circularly rotated transmit vectors is performed by a maximum likelihood receiver.

23. The method of diversity reception of claim 22, wherein the maximum likelihood receiver uses a decoding process that provides more weight to decoding symbols having a high signal to noise (SNR) ratio.

24. A circulant diversity transmitter comprising:
an encoder that receives and encodes a bit stream;
a mapper that maps the encoded bit stream into symbols;
a block former for selecting blocks of the symbols;
a discrete fourier transform (DFT) multiplier for multiplying the blocks of symbols with a DFT matrix forming transmit vectors;
a circular rotator for forming diversity vectors from each transmit vector by circularly rotating each transmit vector; and
a plurality of transmit antenna for transmitting the transmit vectors.

25. The circulant diversity transmitter of claim 24, wherein corresponding elements of the transmit vectors are simultaneously transmitted.

26. The circulant diversity transmitter of claim 24, wherein all elements of the transmit vectors are simultaneously transmitted within a corresponding frequency slot.

27. A circulant diversity receiver comprising:
a receive antenna for receiving a plurality of circularly rotated transmit vectors that were formed by multiplying a plurality of symbols with a discrete fourier transform matrix;
a demodulator for demodulating the transmit vectors and generating a stream of received symbols;
a block former for selecting blocks of the received symbols;
a multiplier for multiplying the selected block with a conjugate transpose of the discrete fourier transform matrix; and
an estimator for estimating transmitted symbols from an output of the multiplier.

28. The circulant diversity receiver of claim 27, wherein the estimator comprises a maximum likelihood receiver.

29. The circulant diversity receiver of claim 28, wherein the maximum likelihood receiver provides more weight to decoding symbols having a high signal to noise (SNR) ratio.
